(19) United States
(12) Patent Application Publication
(10) Pub. No.: US 2023/0280100 A1
(43) Pub. Date: Sep. 7, 2023

(54) Radiator Assembly with Multiple Fans

(71) Applicant: L & M Radiator, Inc., Hibbing, MN (US)

(72) Inventors: Timothy Cass, Hibbing, MN (US); Samuel Rodenberg, Hibbing, MN (US); Josh Mitchell, Hibbing, MN (US)

(21) Appl. No.: 17/687,795

(22) Filed: Mar. 7, 2022

(51) Int. Cl. F28D 1/02; F28F 9/00

(52) U.S. Cl. CPC F28D 1/024; F28F 9/002

(57) ABSTRACT

A radiator assembly includes a frame and a radiator mounted to the frame proximate a front of frame and defining a radiator plane extending along a front surface of the radiator. Each of a plurality of fans is mounted to the frame rearwardly of the radiator, with each fan defining a fan rotation axis that extends outwardly and rearwardly away from the frame.

### FIELD

Aspects of this invention relate generally to a radiator assembly with multiple fans, and, in particular, to a radiator assembly with a radiator and multiple fans that are angled with respect to a front surface of the radiator.

### BACKGROUND

Heavy-duty equipment may include a radiator and multiple fans that pass very high volumes of air through the radiator to provide cooling for the engine of the heavy-duty equipment. It may be desirable to have the fans in close proximity to the radiator in order to make the radiator assembly compact and provide a better fit within the vehicle. However, moving the fans closer to the radiator may provide a less efficient airflow, which can provide less cooling and require more power to provide the necessary cooling for the engine.

It would be desirable to provide a radiator assembly with multiple fans with an improved configuration to provide a more compact assembly while still providing efficient airflow and reasonable power requirements. Particular objects and advantages will be apparent to those skilled in the art, that is, those who are knowledgeable or experienced in this field of technology, in view of the following disclosure of the invention and detailed description of certain embodiments.

### SUMMARY

Aspects of the present invention may be used to advantageously provide a radiator assembly including a radiator and multiple fans that are angled with respect to a plane defined by a front of the radiator. Such a radiator can provide improved cooling for a vehicle in a compact configuration, while reducing restrictions on the airflow through the radiator, thereby increasing airflow through the radiator while reducing the power required.

In accordance with a first aspect, a radiator assembly includes a frame, and a radiator mounted to the frame proximate a front of frame and defining a radiator plane extending along a front surface of the radiator. Each of a plurality of fans is mounted to the frame rearwardly of the radiator, with each fan defining a fan rotation axis that extends outwardly and rearwardly away from the frame.

In accordance with another aspect, a radiator assembly includes a frame and a radiator mounted to the frame proximate a front of frame and defining a radiator plane extending along a front surface of the radiator. The radiator includes a first tank including a plurality of first apertures on an upper surface thereof. A second tank is spaced above the first tank, and includes a plurality of second apertures on a lower surface thereof and a plurality of third apertures on an upper surface thereof. A third tank is positioned above the second tank and includes a plurality of fourth apertures on a lower surface thereof. Each of a plurality of first flow tubes has a first end received in one of the first apertures and a second end received in one of the second apertures. Each of a plurality of second flow tubes has a first end received in one of the third apertures and a second end received in one of the fourth apertures. A first pair of fans is mounted on a first side of the frame rearwardly of the radiator. A second pair of fans is mounted to a second side of the frame rearwardly of the radiator. Each fan defines a fan rotation axis that extends outwardly and rearwardly away from the frame at an acute angle with respect to the radiator plane.

In accordance with further aspects, a radiator assembly includes a frame, and a radiator mounted to the frame proximate a front of frame and defining a radiator plane extending along a front surface of the radiator. The radiator includes a first tank including a plurality of first apertures on an upper surface thereof. A second tank is spaced above the first tank, and includes a plurality of second apertures on a lower surface thereof and a plurality of third apertures on an upper surface thereof. A third tank is positioned above the second tank and includes a plurality of fourth apertures on a lower surface thereof. Each of a plurality of first flow tubes has a first end received in one of the first apertures and a second end received in one of the second apertures. Each of a plurality of second flow tubes has a first end received in one of the third apertures and a second end received in one of the fourth apertures. A first fan is mounted to the frame rearwardly of the radiator proximate a bottom of the frame on a first side of the frame. A second fan is mounted to the frame proximate a top of the frame and directly above the first fan. A third fan is mounted to the frame rearwardly of the radiator proximate a bottom of the frame on a second side of the frame. A fourth fan is mounted to the frame proximate a top of the frame and directly above the third fan. Each fan defines a fan rotation axis that extends outwardly and rearwardly away from the frame at an acute angle with respect to the radiator plane.

From the foregoing disclosure, it will be readily apparent to those skilled in the art, that is, those who are knowledgeable or experienced in this area of technology, that preferred embodiments of a radiator with multiple fans provided in an angled orientation may provide a significant technological advance in terms of improved operation. These and additional features and advantages will be further understood from the following detailed disclosure of certain preferred embodiments.

### BRIEF DESCRIPTION OF THE DRAWINGS

FIG. 1 is a front perspective view of a radiator assembly with multiple fans provided in an angled orientation.

FIG. 2 is a rear perspective view of the radiator assembly of FIG. 1.

FIG. 3 is a plan view of the radiator assembly of FIG. 1.

FIG. 4 is a front elevation view of the radiator assembly of FIG. 1.

The figures referred to above are not drawn necessarily to scale and should be understood to provide a representation of the invention, illustrative of the principles involved. Some features of the radiator assembly depicted in the drawings have been enlarged or distorted relative to others to facilitate explanation and understanding. The same reference numbers are used in the drawings for similar or identical components and features shown in various alternative embodiments. Radiator assemblies as disclosed herein would have configurations and components determined, in part, by the intended application and environment in which they are used.

### DETAILED DESCRIPTION OF CERTAIN PREFERRED EMBODIMENTS

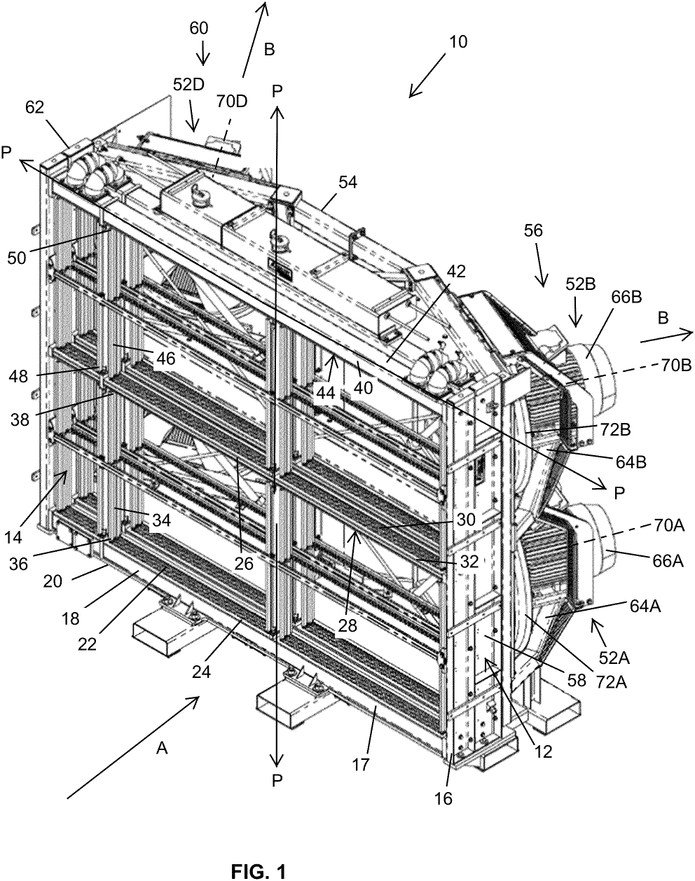

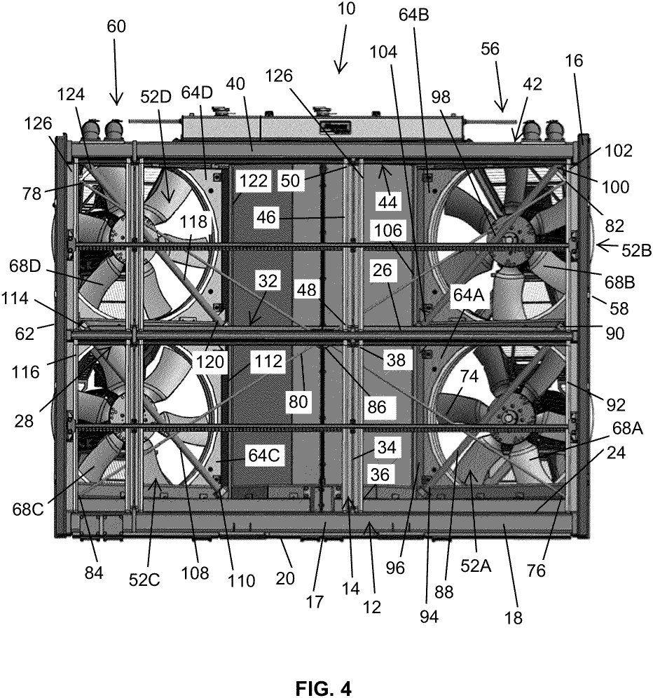

The present invention may be embodied in various forms. An embodiment of a radiator assembly 10 is shown in FIGS. 1-4. For convenience, the terms “upper” and “lower” and “top” and “bottom” are used herein to differentiate between the upper and lower ends of radiator assembly 10 and particular components of the assembly. It is to be appreciated that “upper” and “lower” and “top” and “bottom” are used only for ease of description and understanding and that they are not intended to limit the possible spatial orientations of radiator assembly 10 or its components during assembly or use.

The term “substantially”, as used herein, is meant to mean mostly, or almost the same as, within the constraints of sensible commercial engineering objectives, costs, manufacturing tolerances, and capabilities in the field of radiator assembly installation. Similarly, the term “approximately” as used herein is meant to mean close to, or about a particular value, within the constraints of sensible commercial engineering objectives, costs, manufacturing tolerances, and capabilities in the field of radiator assembly installation.

Radiator assembly 10 may include a frame 12 that may be mounted to a vehicle in which radiator assembly 10 is positioned, and to which elements of radiator assembly 10 are attached. A radiator 14 may be mounted to frame 12 proximate a front 16 of frame 12. Radiator 14 may define a radiator plane P that extends along and is substantially parallel to a front surface 17 of radiator 14.

Radiator 14 may include a first tank 18 positioned proximate a bottom 20 of frame 12. First tank 18 may include a plurality of first apertures 22 on an upper surface 24 thereof, providing fluid communication to a reservoir (not visible) within first tank 18. A second tank 26 may be positioned above first tank 18 in a central portion of frame 12, and may include a plurality of second apertures (not visible) on a lower surface 28 thereof, thereby providing fluid communication to a reservoir (not visible) within second tank 26. A plurality of third apertures 30 may be provided on an upper surface 32 of second tank 26, thereby providing fluid communication to the reservoir (not visible) within second tank 26.

A plurality of first flow tubes 34 may extend between first tank 18 and second tank 26. For purposes of clarity, only a small number of the entire number of first flow tubes 34 are illustrated in the drawings provided here in order that inner portions of radiator assembly 10 are visible in the drawings. A first end 36 of each first flow tube 34 may be received in one of the first apertures 22 in first tank 18, and a second end 38 of each first flow tube 34 may be received in one of the second apertures in second tank 26, thereby providing fluid communication between first tank 18 and second tank 26.

A third tank 40 may be positioned above second tank 26, proximate a top 42 of frame 12, and may include a plurality of fourth apertures (not visible) on a lower surface 44 thereof, thereby providing fluid communication to a reservoir (not visible) within third tank 40.

A plurality of second flow tubes 46 may extend between second tank 26 and third tank 40. For purposes of clarity, only a small number of the entire number of second flow tubes 46 are illustrated in the drawings provided here in order that inner portions of radiator assembly 10 are visible in the drawings. A first end 48 of each second flow tube 46 may be received in one of the third apertures 30 in second tank 26, and a second end 50 of each second flow tube 46 may be received in one of the fourth apertures in third tank 40, thereby providing fluid communication between second tank 26 and third tank 40.

It is to be appreciated that, in certain embodiments, radiator assembly 10 may include only a first tank proximate bottom 20 of frame 12, and a second tank proximate top 42 of frame 12, with a single set of flow tubes extending between and in fluid communication with the reservoirs in the first and second tanks.

A plurality of fans 52 may be mounted at a rear 54 of frame 12 in order to draw air across first flow tubes 34 and second flow tubes 46 of radiator 14 to provide cooling for the heated liquid flowing through radiator 14. Air may be drawn by fans 52 across radiator 14 from the front 16 of frame 12 toward rear 54 of frame 12 in the direction of arrow A, and then through fans 52 rearwardly and outwardly away from frame 12 in the direction of arrows B.

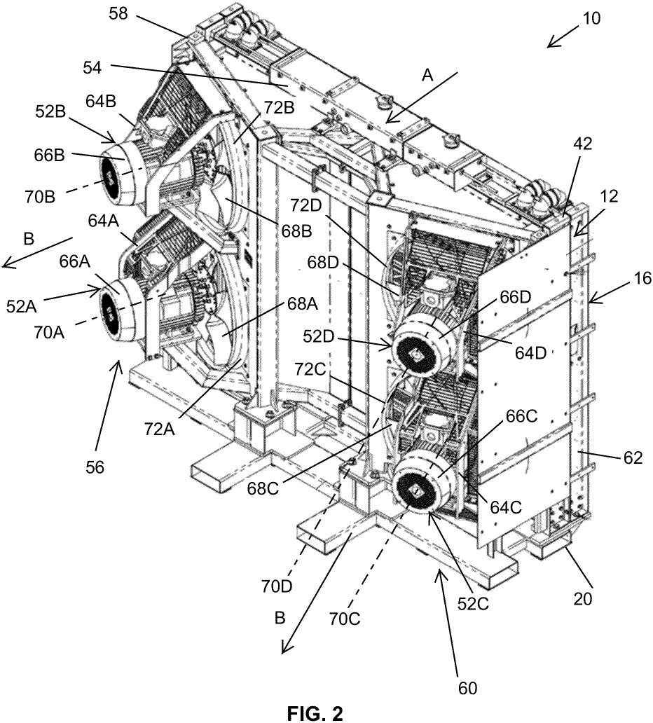

In the illustrated embodiment, four fans 52A-D are mounted to frame 12 rearwardly of radiator 13. A first pair 56 of fans (52A, 52B) may be positioned on a left or first side 58 of frame 12, when viewed from rear 54 of frame 12, as seen in FIG. 2. Similarly, a second pair 60 of fans (52C, 52D) may be positioned on a right or second side 62 of frame 12, when viewed from the rear of radiator assembly 10.

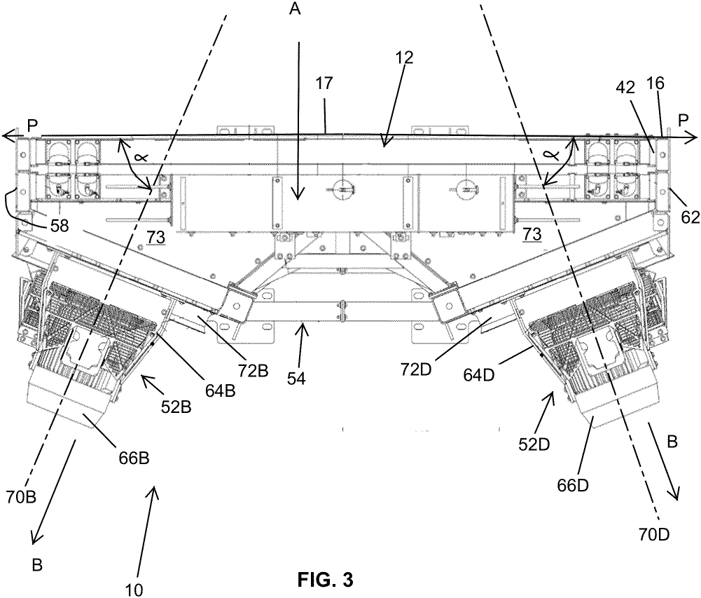

Each fan 52A-D may include a fan housing 64A-D and a motor 66A-D. Each fan 52A-D may include a plurality of blades 68A-D rotatably driven by motor 66A-D about a fan rotation axis 70A-D, and a fan shroud or fan ring 72A-D surrounding blades 68A-D. Each fan 52A-D may be oriented such that its motor 66A-D extends away from fan housing 60A-D rearwardly and outwardly with respect to frame 12. As seen most clearly in FIG. 3, fans 52A-D may be pivoted or rotated with respect to radiator 14 such that fan rotation axes 70A-D extend at an acute angle α with respect to plane P of radiator 14.

A first fan 52A may be mounted on first side 58 of frame 12 proximate bottom 20, and a second fan 52B may be mounted on first side 58 of frame 12 proximate top 42 above first fans 52A such that second fan rotation axis 70B of second fan 52B is vertically aligned with first fan rotation axis 70A of first fan 52A.

A third fan 52c may be mounted on second side 62 of frame 12 proximate bottom 20, and a fourth fan 52D may be mounted on second side 62 of frame 12 proximate top 42 above third fan 52C such that fourth fan rotation axis 70D of fourth fan 52D is vertically aligned with third fan rotation axis 70C of third fan 52C.

First fan rotation axis 70A of first fan 52A may be horizontally aligned with third fan rotation axis 70C of third fan 52C, and second fan rotation axis 70B of second fan 52B may be horizontally aligned with fourth fan rotation axis 70D of fourth fan 52D.

By pivoting or rotating fans 52A-D in such a fashion with respect to frame 12, fan assembly may have a more compact configuration. The outward portions of fans 52A-D are positioned closer to radiator 14 while the inward portions of fans 52A-D are positioned farther away from radiator 14 such that fan rotations axes 70A-D are at an acute angle with respect to plane P of radiator 14. Such a compact configuration may reduce restrictions on the airflow through the radiator, thereby increasing airflow through the radiator while reducing the power required.

Additionally, since pivoting or rotating fans 52A-D in such a fashion with respect to frame 12 serves to direct the heated air that has passed across radiator 14 rearwardly and outwardly, this helps direct the heated air away from the engine of the vehicle (not shown) and associated vehicle components that are positioned rearwardly of radiator 14, which can help cool the engine and other components.

It is to be appreciated that fan housings 64A-D are oriented, as seen in FIG. 3, to support fans 52A-D such that fan housings 64A-D do not obstruct the airflow across radiator 14 and fans 52A-D, and also provide a space 73 between radiator 14 and fans 52A-D to promote even airflow across radiator 14.

A first radiator brace 74 may have a first end 76 connected or secured to frame 12 proximate bottom 20 on first side 58 of frame 12, and an opposed second end 78 connected or secured to frame 12 proximate top 42 on second side 62 of frame 12 such that first radiator brace 74 extends diagonally across frame 12.

A second radiator brace 80 may have a first end 82 connected or secured to frame 12 proximate top 42 on first side 58 of frame 12, and an opposed second end 84 connected or secured to frame 12 proximate bottom 20 on second side 62 of frame 12 such that second radiator brace 80 extends diagonally across frame 12.

A central portion of each of first radiator brace 74 and second radiator brace 80 may be secured to a bracket 86 in a central area of radiator 14, with bracket 86 being secured directly to frame 12.

A first fan brace 88 may have a first end 90 connected or secured to a first side 92 of first fan housing 64A and a second end 94 connected or secured to a second side 96 of first fan housing 64A. A second fan brace 98 may have a first end 100 connected or secured to a first side 102 of second fan housing 64B and a second end 104 connected or secured to a second side 106 of second fan housing 64B. A third fan brace 108 may have a first end 110 connected or secured to a first side 112 of third fan housing 64C and a second end 114 connected or secured to a second side 116 of third fan housing 64C. A fourth fan brace 118 may have a first end 120 connected or secured to a first side 122 of fourth fan housing 64D and a second end 124 connected or secured to a second side 126 of fourth fan housing 64D.

Various embodiments of a radiator assembly have been described herein, which include various components and features. In other embodiments, the radiator assembly may be provided with any combination of such components and features. It is also understood that in other embodiments, the various devices, components, and features of the radiator assembly described herein may be constructed with similar structural and functional elements having different configurations, including different ornamental appearances.

Those having skill in the art, with the knowledge gained from the present disclosure, will recognize that various changes can be made to the disclosed apparatuses and methods in attaining these and other advantages, without departing from the scope of the present disclosure. As such, it should be understood that the features described herein are susceptible to modification, alteration, changes, or substitution. For example, it is expressly intended that all combinations of those elements and/or steps which perform substantially the same function, in substantially the same way, to achieve the same results are within the scope of the embodiments described herein. Substitutions of elements from one described embodiment to another are also fully intended and contemplated. The specific embodiments illustrated and described herein are for illustrative purposes only, and not limiting of that which is set forth in the appended claims. Other embodiments will be evident to those of skill in the art. It should be understood that the foregoing description is provided for clarity only and is merely exemplary. The spirit and scope of the present disclosure is not limited to the above examples, but is encompassed by the following claims.

What is claimed is:

1. A radiator assembly comprising:
a frame;
a radiator mounted to the frame proximate a front of frame and defining a radiator plane extending along a front surface of the radiator; and
a plurality of fans mounted to the frame rearwardly of the radiator, each fan defining a fan rotation axis that extends outwardly and rearwardly away from the frame.

2. The radiator assembly of claim 1, wherein each fan rotation axis extends outwardly and rearwardly away from the frame at an acute angle with respect to the radiator plane.

3. The radiator assembly of claim 1, wherein four fans are mounted to the frame.

4. The radiator assembly of claim 1, wherein a first pair of fans are mounted to a first side of the frame, and a second pair of fans are mounted to a second side of the frame.

5. The radiator assembly of claim 4, wherein the first pair of fans includes a first fan mounted proximate a bottom of the frame, and a second fan mounted above the first fan proximate a top of the frame, and the second pair of fans includes a third fan mounted proximate the bottom of the frame, and a fourth fan mounted above the third fan proximate the top of the frame.

6. The radiator assembly of claim 5, wherein the fan rotation axis of the first fan is vertically aligned with the fan rotation axis of the second fan, and the fan rotation axis of the third fan is vertically aligned with the fan rotation axis of the fourth fan.

7. The radiator assembly of claim 5, wherein the fan rotation axis of the first fan is horizontally aligned with the fan rotation axis of the third fan, and the fan rotation axis of the second fan is horizontally aligned with the fan rotation axis of the fourth fan.

8. The radiator assembly of claim 1, further comprising a plurality of fan rings, each fan ring surrounding blades of one of the fans.

9. The radiator assembly of claim 1, wherein the radiator includes:
a first tank including a plurality of first apertures on an upper surface thereof;
a second tank spaced above the first tank and including a plurality of second apertures on a lower surface thereof; and
a plurality of first flow tubes, each first flow tube having a first end received in one of the first apertures and a second end received in one of the second apertures.

10. The radiator assembly of claim 9, wherein the second tank includes a plurality of third apertures on an upper surface thereof, and further comprising:
a third tank positioned above the second tank and including a plurality of fourth apertures on a lower surface thereof; and
a plurality of second flow tubes, each second flow tube having a first end received in one of the third apertures and a second end received in one of the fourth apertures.

11. The radiator assembly of claim 1, further comprising:
a first radiator brace having a first end connected to the frame proximate a bottom of the frame on a first side of the frame, and a second end connected to the frame proximate a top of the frame on a second side of the frame; and
a second radiator brace having a first end connected to the frame proximate a top of the frame on the first side of the frame, and a second end connected to the frame proximate a bottom of the frame on a second side of the frame.

12. The radiator assembly of claim 11, wherein a central portion of the first radiator brace is secured to the frame and a central portion of the second radiator brace is secured to the frame.

13. The radiator assembly of claim 1, further comprising:
a first fan brace having a first end connected to the frame proximate a top of the first fan on a first side of the first fan, and a second end connected to the frame proximate a bottom of the first fan on a second side of the first fan;
a second fan brace having a first end connected to the frame proximate a top of the second fan on a first side of the second fan, and a second end connected to the frame proximate a bottom of the second fan on a second side of the second fan;
a third fan brace having a first end connected to the frame proximate a bottom of the third fan on a first side of the third fan, and a second end connected to the frame proximate a top of the third fan on a second side of the third fan; and
a fourth fan brace having a first end connected to the frame proximate a bottom of the fourth fan on a first side of the fourth fan, and a second end connected to the frame proximate a top of the fourth fan on a second side of the fourth fan.

14. A radiator assembly comprising:
a frame;
a radiator mounted to the frame proximate a front of frame and defining a radiator plane extending along a front surface of the radiator, the radiator including a first tank including a plurality of first apertures on an upper surface thereof, a second tank spaced above the first tank and including a plurality of second apertures on a lower surface thereof and a plurality of third apertures on an upper surface thereof, a third tank positioned above the second tank and including a plurality of fourth apertures on a lower surface thereof, a plurality of first flow tubes, each first flow tube having a first end received in one of the first apertures and a second end received in one of the second apertures, and a plurality of second flow tubes, each second flow tube having a first end received in one of the third apertures and a second end received in one of the fourth apertures; and
a first pair of fans mounted on a first side of the frame rearwardly of the radiator, and a second pair of fans mounted to a second side of the frame rearwardly of the radiator, each fan defining a fan rotation axis that extends outwardly and rearwardly away from the frame at an acute angle with respect to the radiator plane.

15. The radiator assembly of claim 14, wherein the first pair of fans includes a first fan mounted proximate a bottom of the frame, and a second fan mounted above the first fan proximate a top of the frame, and the second pair of fans includes a third fan mounted proximate the bottom of the frame, and a fourth fan mounted above the third fan proximate the top of the frame.

16. The radiator assembly of claim 15, wherein the fan rotation axis of the first fan is vertically aligned with the fan rotation axis of the second fan, and the fan rotation axis of the third fan is vertically aligned with the fan rotation axis of the fourth fan.

17. The radiator assembly of claim 15, wherein the fan rotation axis of the first fan is horizontally aligned with the fan rotation axis of the third fan, and the fan rotation axis of the second fan is horizontally aligned with the fan rotation axis of the fourth fan.

18. The radiator assembly of claim 14, further comprising a plurality of fan rings, each fan ring surrounding blades of one of the fans.

19. The radiator assembly of claim 14, further comprising:
a first radiator brace having a first end connected to the frame proximate a bottom of the frame on a first side of the frame, and a second end connected to the frame proximate a top of the frame on a second side of the frame; and
a second radiator brace having a first end connected to the frame proximate a top of the frame on a first side of the frame, and a second end connected to the frame proximate a bottom of the frame on a second side of the frame.

20. A radiator assembly comprising:
a frame;
a radiator mounted to the frame proximate a front of frame and defining a radiator plane extending along a front surface of the radiator, the radiator including a first tank including a plurality of first apertures on an upper surface thereof, a second tank spaced above the first tank and including a plurality of second apertures on a lower surface thereof and a plurality of third apertures on an upper surface thereof, a third tank positioned above the second tank and including a plurality of fourth apertures on a lower surface thereof, a plurality of first flow tubes, each first flow tube having a first end received in one of the first apertures and a second end received in one of the second apertures, and a plurality of second flow tubes, each second flow tube having a first end received in one of the third apertures and a second end received in one of the fourth apertures;
a first fan mounted to the frame rearwardly of the radiator proximate a bottom of the frame on a first side of the frame;
a second fan mounted to the frame proximate a top of the frame and directly above the first fan;
a third fan mounted to the frame rearwardly of the radiator proximate a bottom of the frame on a second side of the frame; and
a fourth fan mounted to the frame proximate a top of the frame and directly above the third fan,
wherein each fan defines a fan rotation axis that extends outwardly and rearwardly away from the frame at an acute angle with respect to the radiator plane.
